(19) United States
(12) Patent Application Publication
(10) Pub. No.: US 2011/0053776 A1
(43) Pub. Date: Mar. 3, 2011

(54) BLENDS OF MICRO-ENCAPSULATED PESTICIDE FORMULATIONS

(76) Inventor: James T. BAHR, Hopewell, NJ (US)

(21) Appl. No.: 12/872,255

(22) Filed: Aug. 31, 2010

Related U.S. Application Data
(60) Provisional application No. 61/238,922, filed on Sep. 1, 2009.
(60) Provisional application No. 61/263,610, filed on Nov. 23, 2009.

(51) Int. Cl. A01N 43/80; A01P 13/00

(52) U.S. Cl. 504/271

(57) ABSTRACT

The present invention is directed to micro-encapsulated formulations of soil-active pest control and agricultural chemicals such as herbicides, insecticides, nematicides and fungicides (pesticides) that combine a strong initial activity and a longer residual activity in the soil than provided by current micro-encapsulated formulations. These formulations are prepared by combining two separate suspensions of microcapsules, containing one or more pesticides, which were separately prepared under differing conditions and therefore have significantly different chemical properties and field release rates. The present invention, in particular, is useful for the herbicide clomazone, alone or in combination with other herbicides.

### CROSS REFERENCE TO RELATED APPLICATION

This application claims the benefit of U.S. Provisional Patent Application No. 61/238,922 filed Sep. 1, 2009 and U.S. Provisional Patent Application No. 61/263,610 filed Nov. 23, 2009 the entirety of both of which are hereby incorporated by reference into this application.

### BACKGROUND OF THE INVENTION

1. Field of the Invention

The present invention relates to new and useful pesticidal compositions and particularly relates to herbicidal compounds requiring special precautions when being applied to reduce or prevent vapor transfer thereof to plants which are not the target of application of the compounds, and/or for which longer duration pest control is desired.

2. Description of Related Art

Agricultural chemicals, particularly herbicides, are conventionally used in a wide variety of formulation types, including solid formulations, such as powders, dusts and granules, and liquid formulations, such as solutions, emulsifiable oil concentrates, and suspensions of solids in liquid carriers, or time-release microcapsules dispersed in an aqueous and organic solvent or oil carrier. The choice of which type of selected formulation to be used is generally governed by many considerations, such as the physical and chemical characteristics of the active ingredients, the crop or weed species to which the formulation is to be applied, and whether the application is better made postemergence or preemergence.

Delayed-release formulations are chosen normally to limit the release of the pesticide to regions of the environment other than the location of the pest organism to be controlled. Microencapsulation of the pesticide is one delivery form often selected for providing the desired delayed-release. Applying microencapsulated pesticide has, in some cases, the disadvantage of substantially sacrificing the activity of the pesticide at the proper point of time, e.g., soon after application. Micro-encapsulated formulations have been prepared containing alone or in mixtures trifluralin, alachlor, butachlor, propachlor, triallate, metribuzin, linuron, and pyrethriods (U.S. Pat. No. 4,107,292, U.S. Pat. No. 4,360,376, U.S. Pat. No. 4,280,833, U.S. Pat. No. 4,497,793). The related art also teaches the physical property requirements for successful micro-encapsulation and so microcapsules should be possible for thiobencarb, acetochlor, dimethenamid, terbufos, carbosulfan, cypermethrin, zeta-cypermethrin, permethrin, bifenthrin and selected other pesticides.

Conventionally, the pesticide is, or is dissolved in, an oil and the micro-capsule walls are formed around micro-droplets of this oil suspended in water. Micro-encapsulation can also be carried out with pesticides and other compounds which are soluble or suspendable in water, wherein the micro- capsule walls are formed around micro-droplets of this water suspended in an oil. This technology is generally referred to as reverse-phase micro-encapsulation, as described in U.S. Pat. No. 4,534,783, U.S. Patent No. 6,113,935, U.S. Pat. No. 6,359,031, U.S. Pat. No. 6,534,094, and U.S. Patent Application Publication No. 2009/0053271, all hereby incorporated by reference into this application.

Formulations containing a microencapsulated pesticide have been prepared in which a second pesticide is also present, often present in the suspending liquid medium chosen for the microcapsules and thus able to be released immediately upon application to the crop or other pest-containing location. This combination formulation is especially suited for combinations of an insecticide with a synergist or a herbicide with a safener (U.S. Pat. No. 5,229,122, U.S. Patent Application Publication No. 2005/0255137, DE 2411373, U.S. Pat. No. 5,178,872, U.S. Patent Application Publication No. 2008/0176746).

Thus microencapsulated formulations of selected pesticides are well-known and utilized in agriculture in which the microcapsules contain one or more pesticidally active agents. In these formulations it is known that one can also include pesticidally active insecticides in the suspending medium to provide a high initial “knockdown” activity, or other biologically active agents to pre-condition the pest or target crop so the encapsulated compound will be more active on the pest or more tolerated by the crop (U.S. Pat. No. 5,229,122). Further it is known that microcapsules of two differing pesticidal compounds can be combined in the same suspension, which can be useful if the two compounds are incompatible (U.S. Patent Application Publication No. 2005/0266996, U.S. Patent Application Publication No. 2008/0176746). Compositions containing two or more separately-prepared populations of microcapsules with divergent release rates of the same active ingredient have not been described in the prior art of which applicant is aware.

An excellent selective soil applied herbicide commercially available for controlling many broadleaf and grass weeds, in soybean, cotton, sugarcane, rice, tobacco, oilseed rape, vegetables and other crops has the common name clomazone which chemically is 2-[(2-chlorophenyl)methyl]-4,4-dimethyl-3-isoxazolidinone. Clomazone is an effective herbicide as evidenced by its ability to control, at low application rates in crops, a broad spectrum of grasses and broadleaf weeds that compete with crops. Unfortunately, clomazone has a high vapor pressure and is phytotoxic to some non-targeted crops and naturally occurring plant species when applied to control undesired vegetation. Contact of clomazone with such crops is the result of vapor transfer of the clomazone to sensitive species growing in adjacent areas. Therefore clomazone has been sold for over 20 years now primarily as a micro-encapsulated formulation with significantly reduced risk of vapor transfer to and phytotoxic effects on non-target plant species. The clomazone microcapsules can be prepared as an aqueous suspension or combined with extruded granules (U.S. Pat. No. 5,583,090, U.S. Pat. No. 5,597,780, U.S. Pat. No. 5,783,520, U.S. Pat. No. 6,218,339, U.S. Pat. No. 6,380,133, U.S. Pat. No. 6,440,902, U.S. Pat. No. RE38,675, U.S. Pat. No. 6,797,277).

Growers using clomazone for weed control in rice, especially in the southern United States, have been generally pleased with its control of key weed species. However control of grass weeds by clomazone does not always last until the permanent flood. As a consequence, growers either must incur the cost of a follow-up treatment with post-emergent grass herbicides (herbicide and application costs) or, as some have chosen to do, apply the permitted dose of clomazone in two sequential applications a few weeks apart. This second approach results in sufficient clomazone being present up to the time of the permanent flood to give excellent grass weed control in rice, but growers must bear the additional cost of a second application.

In other crops in which clomazone and other herbicides are used, an increased duration of residual control can also be desired by growers, up to the point of canopy closure.

It is desirable to provide a system for formulating clomazone and other soil-active pesticides so that movement to non-target plants and/or groundwater is significantly reduced and so that the duration of pest control is increased.

### SUMMARY OF THE INVENTION

The present invention relates generally to the field of pesticidal chemical formulations. The current invention provides a method for extending the duration of pest control for any compound that can be successfully micro-encapsulated by either normal phase or reverse phase micro-encapsulation methods. In the normal phase method, the pesticide is, or is dissolved in, an oil and the micro-capsule walls are formed around micro-droplets of this oil suspended in water. In the reverse phase microencapsulation method, the microencapsulation is carried out with pesticides and other compounds which are soluble or suspendable in water and the micro- capsule walls are formed around micro-droplets of this water suspended in an oil. In particular, the present invention relates to novel compositions of a herbicidal compound, namely clomazone, designed to reduce clomazone's characteristic volatility, thereby reducing risk of unintended herbicidal activity, and extend its duration of effective weed control, when clomazone is applied and providing growers with more effective weed control. Clomazone chemically is 2-[(2-chlorophenyl)methyl]-4,4-dimethyl-3-isoxazolidinone. The herbicidally active ingredient to which the present invention is concerned will be referred to herein by its common name of clomazone.

The present invention provides adequate suppression of volatility of clomazone (and other compounds) while also providing a longer time of acceptable weed control. It does so by combining micro-encapsulated suspensions of clomazone with micro-encapsulated suspensions of clomazone having a significantly slower release rate.

### DETAILED DESCRIPTION

The present invention provides a plurality of conditions using effective processes for preparing micro-encapsulated clomazone and other pesticides. In a first condition, the methods and conditions used are similar to those described in U.S. Pat. No. RE38,675, or alternatively in U.S. Pat. No. 5,583,090, hereby incorporated by reference into this application. In a second condition, the conditions are modified so that the walls of the microcapsules are thicker and generally less porous, accordingly the clomazone and other pesticides contained within these microcapsules is released much more slowly than in those prepared under the first condition. Alternatively, faster release microcapsules can be used in the present invention and can have a more rapid release rate than conventional products to give a stronger initial activity.

In the present invention, the ratio of the rates of release from the microcapsules is adjusted so that the slower-released pesticide appears outside the microcapsules at a rate adequate to compensate for metabolism and irreversible soil binding of the previously released pesticide and maintain its effective concentration in the soil.

The microcapsules prepared by the second set of conditions may even appear to be relatively ineffective in normal herbicidal evaluations, as they will have released too little of the pesticide in the time frame for such tests. They will however release the pesticide at a rate sufficient to replace that pesticide which is being lost in the root zone due to microbial metabolism or irreversible soil binding in order to extend the duration of effective weed control.

In one embodiment, a combination of clomazone microcapsules prepared by the first set of conditions and clomazone microcapsules prepared by the second set of conditions is prepared in an appropriate ratio, the mixture provides acceptable control of volatility, acceptable initial activity on emerging weeds and acceptable activity on later-emerging weeds, such as those emerging just before the permanent flood is put into place in rice culture (typically about four weeks) or before canopy closure in other crops.

The present invention, the combination of two sets of microcapsules prepared under differing conditions, can be applied to other soil-active pest control chemicals. In some cases, volatility will not be a concern, but extended duration of control will still be of value. In one embodiment, a composition is prepared which is an aqueous suspension or an extruded granule in which are blended two separate sets of microcapsules of a soil-active pesticide in which the microcapsules have been prepared under two significantly different sets of conditions, to give two significantly different release rates, and then blended in a ratio to give the desired biological activity, and the ratio can vary from about 10:1 to about 1:10.

In one embodiment, the rate of release from the more slowly releasing microcapsules is adjusted to a value that will allow the more slowly released material to replace the pesticide in the soil which has been metabolized or irreversibly bound to the soil. The release rate of the more slowly released pesticide may vary from about ½ to about 1/20^{th} the release rate of the more rapidly releasing microcapsules, preferably about ⅓ to about ⅙. In one embodiment, the ratio of the faster releasing microcapsules to the slower releasing microcapsules is between about 3:1 and about 1:9, preferably, the ratio of the faster releasing microcapsules to the slower releasing microcapsules is between about 1:1 and about 1:5 and more preferably the ratio of the faster releasing microcapsules to the slower releasing microcapsules is between about 1:1.5 and about 1:3. The average release rate of the slower releasing microcapsules is about two-fold to about six-fold slower than the first set of faster releasing microcapsules. Alternatively, the average release rate of the slower releasing microcapsules is about three-fold to about five-fold slower than the first set of faster releasing microcapsules.

The effect of extended control via a blend of microcapsules, a portion of which have slower release characteristics, can include an ability to reduce the overall amount of chemical applied to the soil, thus reducing environmental contamination. The present invention will also save growers the cost of additional applications of herbicides. Yet another desirable effect may include the ability to use chemicals whose degradation in the soil is so fast that their effectiveness is otherwise too weak for effective and practical pest control.

The capsules can have a shell composed of a polyurea polymer formed around liquid droplets of the pesticide and containing effective dispersants and stabilizers, wherein the shell comprises between about 5% and about 35% by weight of the shell and the microcapsules have a diameter between about one micron and about 100 microns. Suitable pesticides include metolachlor, acetochlor, dimethenamid, triallate, thiobencarb, butachlor, terbufos, carbosulfan, or clomazone. Clomazone is the preferred pesticide. Clomazone can be present between about 1 and about 4 lbs./gallon. Preferably, clomazone is present at between about 2.5 and about 3.5 lbs./gallon.

The present invention includes a method of controlling undesirable plants species (weeds) by applying the compositions to the locus where a crop is to be grown, either to the soil surface or by incorporation into the soil prior to the emergence of the crop. For example, the crop can be rice. The invention can be further illustrated by the following examples thereof, although it will be understood that these examples are included merely for purposes of illustration and are not intended to limit the scope of the invention unless otherwise specifically indicated. All percentages, ratios, and parts herein, in the Specification, Examples, and Claims, are by weight and are approximations unless otherwise stated.

### EXAMPLE I

Clomazone is prepared under a first condition as a micro-encapsulated aqueous suspension following procedures described in U.S. Pat. No. RE38,675, hereby incorporated by reference into this application, to give a three pound per gallon concentrate with a release rate of 16% (plus or minus 2%) relative to that of clomazone formulated as a 4 EC in an 18 hour interval as assayed by the method in U.S. Pat. No. No. 5,597,780, hereby incorporated by reference into this application.

Clomazone is also prepared separately under a second condition as a micro-encapsulated aqueous suspension using the same general methods as described in U.S. Pat. No. RE38,675, and using the principles described therein, and in U.S. Pat. No. 5,583,090, to adjust the release rate, such as increased particle size, wall thickness, and solvent content, and in light of the equipment used, to give a three pound per gallon concentrate but with the ratios of components adjusted to give a release rate of 4.0% (plus or minus 0.5%) as assayed by the same method.

The conditions of the microencapsulations thus yield a ratio of release rates equal to 4.0.

These two preparations of a clomazone micro-encapsulated suspension are then blended together at a ratio of 30% of the first, faster-releasing, preparation to 70% of the second, slower releasing, formulation, to give the final blended formulation, a three pound per gallon aqueous concentrate.

### EXAMPLE II

Clomazone is prepared as a micro-encapsulated aqueous suspension following procedures described in U.S. Pat. No. RE38,675 to give a three pound per gallon concentrate with a release rate of 16% (plus or minus 2.0%) relative to that of clomazone formulated as a 4 EC in an 18 hour interval as assayed by the method in U.S. Pat. No. 5,597,780, hereby incorporated by reference into this application.

Clomazone is also prepared as a micro-encapsulated aqueous suspension using the same general methods as described in U.S. Pat. No. RE38,675, and using the principles described therein, and in U.S. Pat. No. 5,583,090, to adjust the release rate, such as increased particle size, wall thickness, and solvent content, and in light of the equipment used, to give a three pound per gallon concentrate but with the ratios of components adjusted to give a release rate of 3.6% (plus or minus 0.4%) as assayed by the same method.

The conditions of microencapsulation thus yield a ratio of release rates equal to 4.5.

These two preparations of a clomazone micro-encapsulated suspension are then blended together at a ratio of 30% of the first, faster-releasing, preparation to 70% of the second, slower releasing, formulation, to give the final blended formulation, a three pound per gallon aqueous concentrate.

### EXAMPLE III

Clomazone is prepared as a micro-encapsulated aqueous suspension following procedures described in U.S. Pat. No. RE38,675 to give a three pound per gallon concentrate with a release rate of 16% (plus or minus 2.0%) relative to that of clomazone formulated as a 4 EC in an 18 hour interval as assayed by the method in U.S. Pat. No. 5,597,780, hereby incorporated by reference into this application.

Clomazone is also prepared as a micro-encapsulated aqueous suspension using the same general methods as described in U.S. Pat. No. RE38,675, and using the principles described therein, and in U.S. Pat. No. 5,583,090, to adjust the release rate, such as increased particle size, wall thickness, and solvent content, and in light of the equipment used, to give a three pound per gallon concentrate but with the ratios of components adjusted to give a release rate of 4.6% (plus or minus 0.4%) as assayed by the same method.

The conditions of microencapsulation thus yield a ratio of release rates equal to 3.5.

These two preparations of a clomazone micro-encapsulated suspension are then blended together at a ratio of 30% of the first, faster-releasing, preparation to 70% of the second, slower releasing, formulation, to give the final blended formulation, a three pound per gallon aqueous concentrate.

### EXAMPLE IV

The preparations of clomazone microcapsules described in the above Example I are blended together at a ratio of 40% of the first, faster-releasing, preparation and 60% of the second, slower releasing, formulation to give final blended formulations of all three pound per gallon aqueous concentrates.

### EXAMPLE V

The two preparations of clomazone microcapsules described in the above Example II are blended together at a ratio of 40% of the first, faster-releasing, preparation and 60% of the second, slower releasing, formulation to give final blended formulations of all three pound per gallon aqueous concentrates.

### EXAMPLE VI

The two preparations of clomazone microcapsules described in the above Example III are blended together at a ratio of 40% of the first, faster-releasing, preparation and 60% of the second, slower releasing, formulation to give final blended formulations of all three pound per gallon aqueous concentrates.

It is understood that there may be variations from the specific embodiments described herein without departing from the spirit, scope, or concept of the present invention as defined in the claims. Included in such variations are mixtures in which the encapsulated clomazone is part of a mixture with other herbicides whether or not encapsulated; variations in the release rate of the second slower-releasing microcapsules, variations in the ratios of the two microcapsules preparations. The present invention can as well, be practiced with a variety of other pesticide compounds for which volatility control and/or groundwater contamination control with an extended residual activity is desired. With other pesticides, the rate of release of the active compound from the second set of more slowly releasing microcapsules will need to be adjusted, in light of the soil metabolism and irreversible soil binding characteristics of said pesticide. The more slowly released material will replace that which became ineffective due to metabolism or irreversible soil binding.

It is to be understood that the above-described embodiments are illustrative of only a few of the many possible specific embodiments, which can represent applications of the principles of the invention. The principles of the invention, herein described for normal phase microencapsulation, can also be applied to reverse phase microencapsulation. Numerous and varied other arrangements can be readily devised in accordance with these principles by those skilled in the art without departing from the spirit and scope of the invention.

What is claimed is:

1. A composition comprising an oil or aqueous suspension or an extruded granule in which are blended two separate sets of microcapsules of a soil-active pesticide wherein the microcapsules have been prepared under two significantly different sets of conditions to give two significantly different release rates and then blended in a ratio to give a desired biological activity, and wherein a ratio of faster releasing said microcapsules to more slower releasing said microcapsules is in a range of from about 10:1 to about 1:10.

2. The composition of claim 1 in which the rate of release from the more slowly releasing microcapsules is adjusted to a value that will allow the more slowly released microcapsules to replace pesticide in the soil which has been metabolized or irreversibly bound to the soil and wherein a release rate of the more slowly released pesticide is in a range of from about ½ to about 1/20^{th} a release rate of the faster releasing said microcapsules.

3. The composition of claim 2 wherein the release rate of the more slowly released pesticide is in a range of from about ⅓ to about ⅙.

4. The composition of claim 1 wherein the microcapsules have a shell comprising a polymer formed around liquid droplets of the pesticide or a solution or suspension of the pesticide and containing effective dispersants and stabilizers, wherein the shell comprises between about 5% and about 35% of the weight and the microcapsules.

5. The composition of claim 4 wherein the microcapsules have a shell comprised of polyurea polymer.

6. The composition of claim 1 wherein the pesticide is selected from metolachlor, acetochlor, dimethenamid, triallate, thiobencarb, butachlor, terbufos, carbosulfan, or clomazone.

7. The composition of claim 4 wherein the pesticide is clomazone, said clomazone is present between about 2.5 and about 3.5 lbs./gallon, the ratio of the faster releasing capsules and the more slower releasing capsules in between about 1:1 and about 1:5 and the average release rate of the slower releasing capsules is between about three-fold and about five-fold slower than the faster releasing capsules.

8. The composition of claim 1 wherein the microcapsules have a diameter between about one micron and about 100 microns.

9. The composition of claim 1 wherein the pesticide is clomazone.

10. The composition of claim 9 wherein the clomazone is present between about 2.5 and about 3.5 lbs./gallon, the ratio of the faster releasing capsules and the slower releasing capsules in between about 1:1.5 and about 1:3 and the average release rate of the slower releasing capsules is between three-fold and five-fold slower than the faster releasing capsules.

11. The composition of claim 9 wherein the clomazone is present between about 1 and about 4 lbs./gallon.

12. The composition of claim 11 wherein the clomazone is present at between about 2.5 and about 3.5 lbs./gallon.

13. The composition of claim 1 wherein the ratio of the faster releasing microcapsules to the slower releasing microcapsules is between about 3:1 and about 1:9.

14. The composition of claim 1 wherein the ratio of the faster releasing microcapsules to the slower releasing microcapsules is between about 1:1 and about 1:5.

15. The composition of claim 1 wherein the ratio of the faster releasing microcapsules to the slower releasing microcapsules is between about 1:1.5 and about 1:3.

16. The composition of claim 1 wherein the average release rate of the second set of microcapsules is about two-fold to about six-fold slower than the first set.

17. The composition of claim 1 wherein the average release rate of the second set of microcapsules is about three-fold to about five-fold slower than the first set.

18. The composition of claim 1 wherein the microcapsules are prepared by normal phase micro-encapsulation.

19. The composition of claim 1 wherein the microcapsules are prepared by reverse phase micro-encapsulation.

20. A method of controlling undesirable species comprising the steps of:
applying a composition to the locus where a crop is to be grown, either to the soil surface or by incorporation into the soil prior to the emergence of the crop, wherein the composition comprises an oil or aqueous suspension or an extruded granule in which are blended two separate sets of microcapsules of a soil-active pesticide wherein the microcapsules have been prepared under two significantly different sets of conditions to give two significantly different release rates and then blended in a ratio to give a desired biological activity, and wherein a ratio of faster releasing said microcapsules to more slower releasing said microcapsules is in a range of from about 10:1 to about 1:10.

21. The method of claim 20 wherein the microcapsules have a shell comprising a polymer formed around liquid droplets of the pesticide or a solution or suspension of the pesticide and containing effective dispersants and stabilizers, wherein the shell comprises between about 5% and about 35% of the weight and the microcapsules, wherein the pesticide is clomazone.

22. The method of claim 20 wherein the pesticide is clomazone, said clomazone is present between about 2.5 and about 3.5 lbs./gallon, the ratio of the faster releasing capsules and the more slower releasing capsules in between about 1:1 and about 1:5 and the average release rate of the slower releasing capsules is between about three-fold and about five-fold slower than the faster releasing capsules.

23. A method of controlling undesirable species by applying a composition to the locus where rice is to be grown, either to the soil surface or by incorporation into the soil prior to the emergence of the crop an oil or aqueous suspension or an extruded granule in which are blended two separate sets of microcapsules of a soil-active pesticide wherein the microcapsules have been prepared under two significantly different sets of conditions to give two significantly different release rates and then blended in a ratio to give a desired biological activity, and wherein a ratio of faster releasing said microcapsules to more slower releasing said microcapsules is in a range of from about 10:1 to about 1:10.

24. The method of claim 23 wherein the pesticide is clomazone.

25. The method of claim 23 wherein the clomazone is present between about 2.5 and about 3.5 lbs./gallon, the ratio of the faster releasing capsules and the slower releasing capsules in between about 1:1.5 and about 1:3 and the average release rate of the slower releasing capsules is between three-fold and five-fold slower than the faster releasing capsules.

26. The method of claim 23 wherein the microcapsules are prepared by normal phase micro-encapsulation.

27. The method of claim 23 wherein the microcapsules are prepared by reverse phase micro-encapsulation.
